(19) United States
(12) Patent Application Publication
(10) Pub. No.: US 2023/0230745 A1
(43) Pub. Date: Jul. 20, 2023

(54) ELECTRICAL APPLIANCE COMPRISING A BOILER HAVING A SHAPE COMPLEMENTARY TO THE ACTIVE PART

(71) Applicant: SIEMENS AKTIENGESELLSCHAFT, München (DE)

(72) Inventors: Tobias Englmann, Freystadt (DE); David Weber, Weilersbach (DE); Viktor Wins, Wilhermsdorf (DE); Oliver Meckel, Schwaig (DE); Aime Mbuy, Nürnberg-Weiherhaus (DE)

(21) Appl. No.: 18/011,270

(22) PCT Filed: Jun. 19, 2020
(86) PCT No.: PCT/EP2020/067205

§ 371 Date: Dec. 19, 2022

(51) Int. Cl. H01F 27/06; H01F 27/02; H01F 27/10; H01F 27/26; H01F 27/28; H01F 27/30

(52) U.S. Cl. CPC H01F 27/06; H01F 27/02; H01F 27/10; H01F 27/266; H01F 27/2876; H01F 27/306

(57) ABSTRACT

An electrical appliance for connecting to a high voltage includes an active part, which is provided with a magnetizable core and at least two winding assemblies, each surrounding a core section of the core and having windings that are inductively coupled to one another. The active part is entirely arranged a tank, which can be filled with an insulating fluid. The tank has two end casings and a central part arranged between the end casings. The electrical appliance is compact and has a low tare weight. The central part forms a hollow body for each winding assembly, through which a respective one of the core sections extends, which is surrounded by an associated winding assembly. The hollow bodies are connected to one another on the inside and only via the internal volume of the end casings.

The invention relates to an electrical device for connecting to a high voltage comprising an active part, which is provided with a magnetizable core and at least two winding assemblies, each surrounding a core section of the core and having windings that are inductively coupled to one another, and a tank, which can be filled with an insulating fluid in which the active part is completely arranged, wherein the tank has two end casings and a central part arranged between the end casings.

Such an electrical device is already known from WO 2008/184775 A1. Disclosed there is a railway transformer, which comprises an active part and a housing or tank, in which the active part is disposed. The active part is formed from a core with two core legs, which are each surrounded by two windings arranged concentrically to one another. In this case, the tank has a central part, which surrounds the outer contour of the windings in a shape-complementary manner. In other words, the central part forms two hollow cylinders, whose internal volumes partially overlap. By means of the partially shape-complementary configuration, the internal volume of the housing and therefore the oil volume of the railway transformer can be reduced.

WO 2016/038222A1 discloses a railway transformer with an active part and a tank, wherein the core of the active part is disposed completely outside the housing. The railway transformer is fastened via the core to the rail vehicle so that during travel no forces are introduced into the tank. The tank can therefore consist of a light material such as, for example, plastic.

Railway transformers are provided for mounting on a rail vehicle such as, for example, on a locomotive or a railcar. They are used to provide a desired traction voltage for driving the locomotive or the railcar depending on various input voltages. Previously known railway transformers comprise a metal tank located at ground potential, which is filled with an insulating fluid, for example, an ester liquid. The so-called active part of the transformer is disposed in the tank, which comprises a core consisting of magnetizable sheets as well as at least two windings concentrically surrounding a section of the core. For connection of the transformer to a high voltage, the tank is fitted with feed-throughs.

The previously known electrical device has the disadvantage that the tank is configured to be space-consuming and the electrical device has a high tare weight. In particular in rail applications, however, a compact, light structure is desirable.

It is therefore the object of the invention to provide an electrical device of the type mentioned previously, which is configured to be compact and has a low tare weight.

The invention solves this object whereby the central part for each winding assembly forms a hollow body, through which a respective one of the core sections extends, which is surrounded by its associated winding assembly, wherein the hollow bodies are connected to one another on the inside and only via the internal volume of the end casings.

Within the framework of the invention the tank is not configured to be box-shaped but adapted to the outer contour of at least two winding assemblies. This was already proposed in the prior art mentioned initially but the invention goes further with regard to the configuration of the tank, which is complementary in shape to the winding assemblies. Within the framework of the invention, each winding assembly is completely enclosed by a hollow body of the tank. The insulating fluid can no longer pass from one hollow body to the next as in the aforesaid prior art. On the contrary, the insulating fluid must flow out from the one hollow body into the interior of one of the end casings and only from there can it enter into the other hollow body. In this case, the tank maintains a spacing from the outer winding of the respective winding assembly, which is sufficient in order to ensure the desired voltage strength of the electrical device. As a result of the shape-complementary configuration of the tank over the entire circumference of the tank, at least in the region of the windings, this has a low internal volume so that the tank needs to be filled with a small amount of insulating fluid. As a result of the smaller volume of insulating fluid, the electrical device is lighter and more compact than an electrical device according to the prior art. In view of the smaller amount of insulating fluid, cost advantages are also obtained. Within the framework of the invention, the shape-complementary configuration of the tank is over the entire circumference and not restricted to adaptations in certain surface regions of the winding assemblies.

A magnetizable material is understood here as a ferromagnetic material such as, for example, iron.

Within the framework of the invention, windings of a winding assembly are disposed concentrically to one another. An external winding is, for example, designed as a primary winding for higher voltages than a secondary winding arranged further inward. In addition to a primary and secondary winding, each winding assembly can also have further windings such as, for example, an auxiliary operating winding, a step winding, or the like.

In one variant, the active part has two winding assemblies with, for example, four windings, wherein in each case two windings are disposed concentrically to one another and surround a common leg of the core as core portion. Here, for example, this comprises an inner lower-voltage winding and a higher-voltage winding surrounding the lower-voltage winding. The core expediently has a further leg, which is also surrounded by a lower- or higher-voltage winding. The two lower-voltage and higher-voltage windings are in this case connected in series, for example. In this configuration of the electrical device according to the invention, only the higher-voltage windings define the outer contour of the active part. Each of the two hollow bodies surrounds one of the two winding assemblies. In this case, each hollow body is advantageously configured to be complementary in shape to the outer contour of the two higher-voltage windings. The winding assemblies are advantageously arranged next to one another, wherein they extend in each case in an axial or longitudinal direction. The core legs, which extend in each case through one of the two winding assemblies, are therefore also aligned parallel to one another. In other words, the inner wall of the central part advantageously follows the outer contour of the outer windings of the respective winding assembly over the entire circumference.

Within the framework of the invention, the hollow bodies are preferably dimensioned and configured identically to one another.

Naturally three or more legs can also be provided within the framework of the invention, wherein each leg is fitted with a winding assembly.

Advantageously the end casings are also adapted to the active part portions, which are disposed in the internal volume thereof. According to this further development of the invention, the tank outside its central part not only nestles against the outer contour of the external windings at least in its internal configuration. Rather, the tank is also configured to have a shape complementary to further portions of the active part, which also define the outer contour of the active part. Thus, the core usually has a lower and upper yoke, which extend above or below the front sides of the respective windings. A press frame is usually provided at the upper and lower yoke, by means of which magnetizable sheets of the core abutting flat against one another are pressed toward one another. The upper and lower yoke together with the respective press frame then define the outer contour of the active part, which is not defined by the windings. Whereas the windings, however, define a usually cylindrical outer contour, the remaining outer contour of the active part deviates appreciably from this. The shape-complementary adaptation of the tank to this somewhat more complex outer contour is therefore limited to forming a box-shaped envelope. This means that in its configuration, the tank does not simulate each screw or each bolt but simulates the entire section with a box-shaped and partially beveled contour. This box-shaped contour then delimits an interior which makes it possible to accommodate the said active part portions in a voltage-proof manner but at the same time limits the internal volume of the tank to a minimum.

Advantageously each hollow body is configured as a circular cylindrical tube section. Since the outer contour of a winding arrangement is usually configured to be circular cylindrical, the tube-shaped configuration is the best possibility for minimizing the internal volume of the tank. The longitudinal axis of the tube section and the longitudinal axis of the winding assembly agree in this case. In other words, each tube section is disposed concentrically to the winding assembly, which extends through it.

In a further development to this, the central part forms a plurality of tube sections, which are each provided to receive a winding assembly, wherein, however, the internal volumes of the tube sections do not overlap. In this variant of the invention, an active part is inserted, which comprises three or four winding assemblies, which are aligned parallel and located next to one another and/or under one another. Here also each outer winding can be disposed concentrically to an inner winding. Each of these outer windings is disposed in an associated tube section of the tank, wherein each individual tube section surrounds the windings mounted therein over the entire circumference.

Advantageously the central part comprises two flange portions that are configured to be flat, between which each hollow body extends, and each flange portion is mechanically detachably connected to a flange portion of one of the end casings, wherein sealing means are disposed between flange portions. The central part and the end casings must be connected tightly to one another in order to reliably prevent an undesired escape of insulating fluid from the tank. A flange connection is particularly suitable for this purpose. Thus, it is advantageous if the central part at its two front sides forms a flange portion which extends outward at right angles from the outer contour in the radial direction. Within the framework of this further development, the end casings form a corresponding flange portion, which lies precisely opposite one of the two flange portions of the central part. The flange portions can therefore abut against one another and be pressed toward one another, wherein the sealing means, for example a circumferentially closed circumferential O ring, ensures that no insulating fluid can escape. The pressing can be accomplished, for example, by a screw connection, wherein a screw of the screw connection extends through through-holes in the flange portions of the end casings and engages with its external thread into an internal thread, that engages in holes of the flange portion of the central part which are only open on one side.

Expediently, the central part consists of a plastic. Any expedient polymer comes into consideration as plastic. Plastics are light compared with metal materials so that a further reduction in the tare weight of the electrical device according to the invention is obtained.

Fiber-reinforced plastics, in particular glass-fiber-reinforced plastics are suitable for increasing the mechanical strength.

The end casings are preferably fabricated from a metal or a metal alloy. Advantageously the end casings consist of steel.

Expediently the end casings are each configured to be box-shaped. A box-shaped configuration can be accomplished in series production. In this variant of the invention, an adaptation to the respective active part is omitted. In this way, costs can be saved.

Advantageously at least one end casing has a viewing window and/or a hand opening. According to this further development of the invention, the electrical device can be easily manufactured and maintained.

The electrical device is preferably a railway transformer.

In a preferred variant, the core has two core legs, which are connected to one another via an upper and lower yoke, wherein each core leg extends through a cavity and is surrounded by a winding assembly.

Expediently, the active part is only connected to the tank at the end casings, wherein the end casings are connected to fastening means for mounting on a rail vehicle. In this way, it is avoided that high forces are introduced into the central part, which can therefore be fabricated from a light material.

A light material in the sense of the present invention is any material having a density a factor of two lower than steel. Thus, steel has a density of 7.85-7.87 g/cm³. Materials having a density less than 3.9 g/cm³ are light materials in the sense of the invention. Examples for such light materials are aluminum, plastics, and fiber-reinforced plastics. Preferably the central part substantially consists of a glass-fiber-reinforced plastic having a density of 2.5 g/cm³.

Preferably the end casings are each connected to a cross member of a supporting frame. The supporting frame is simple in terms of its construction and therefore cost-effective. In this case, each end casing rests with a flat underside on the likewise flat upper broad side of the cross member. Expediently spacers are disposed between the yoke with clamping frame and the inner wall of the flat underside. The cross member is preferably designed as a hollow profile support and consists of a mechanically solid material, in particular steel.

Expediently, in the fastened position of the electrical device the active part extends horizontally in its longitudinal direction. In other words, the electrical device configured here as a railway transformer is installed horizontally on the rail vehicle.

Further expedient configurations and advantages of the invention are the subject matter of the following description of exemplary embodiments of the invention with reference to the figures of the drawing, wherein the same reference numbers refer to components having the same effect and wherein

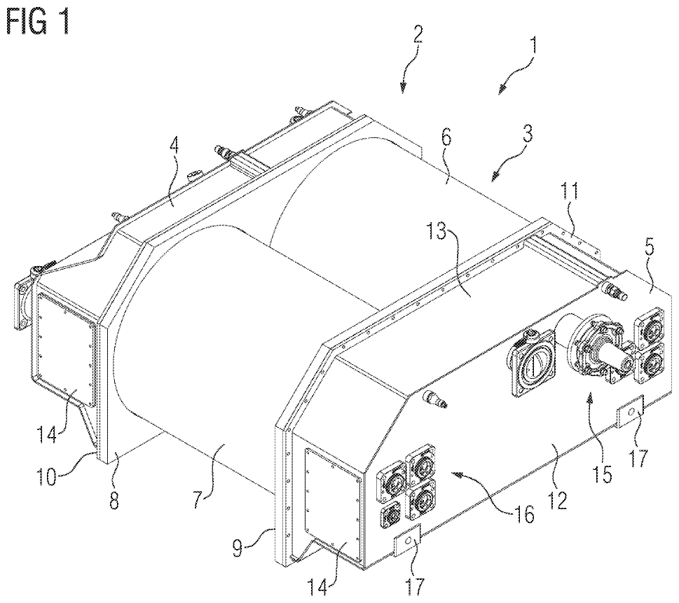

FIG. 1 shows an exemplary embodiment of the electrical device according to the invention,

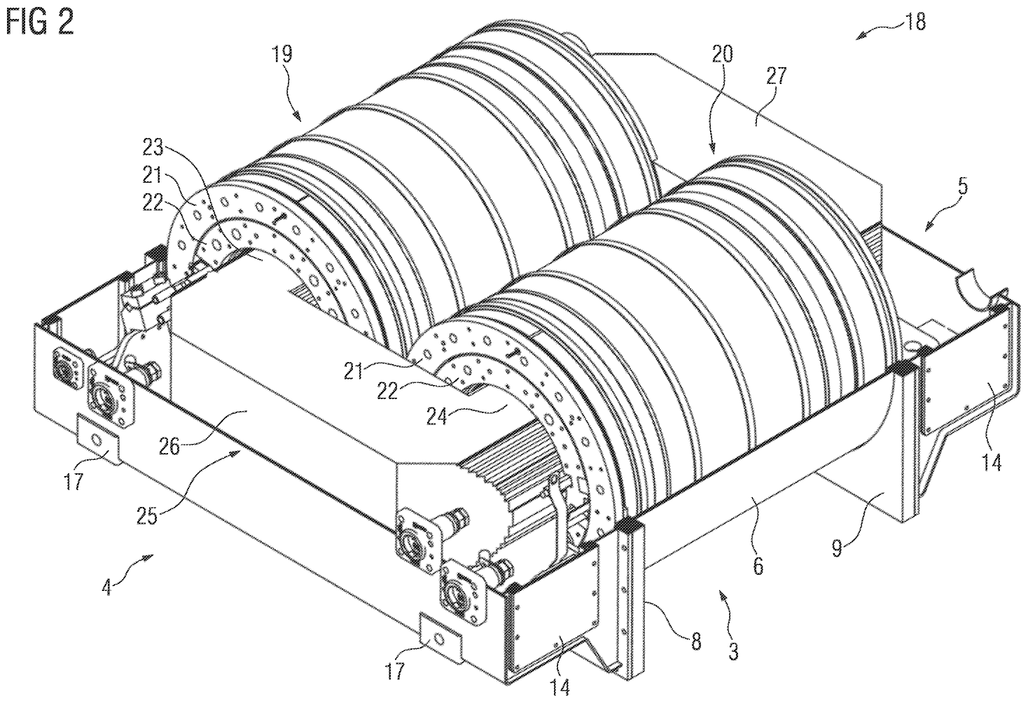

FIG. 2 shows the active part of the electrical device according to FIG. 1,

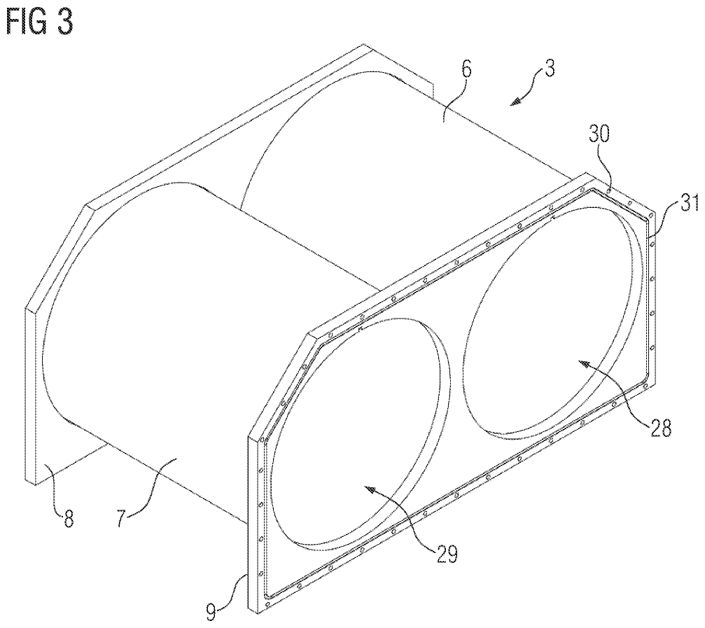

FIG. 3 shows a central part of the electrical device according to FIG. 1,

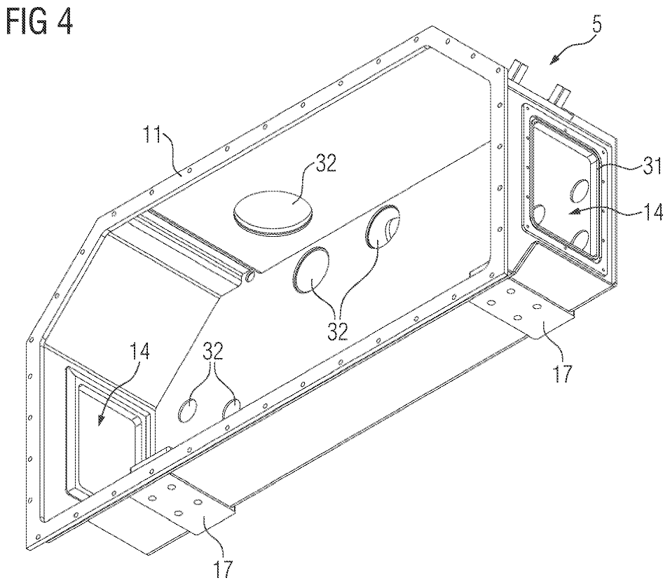

FIG. 4 shows an inner view of an end casing of the electrical device according to FIG. 1, and

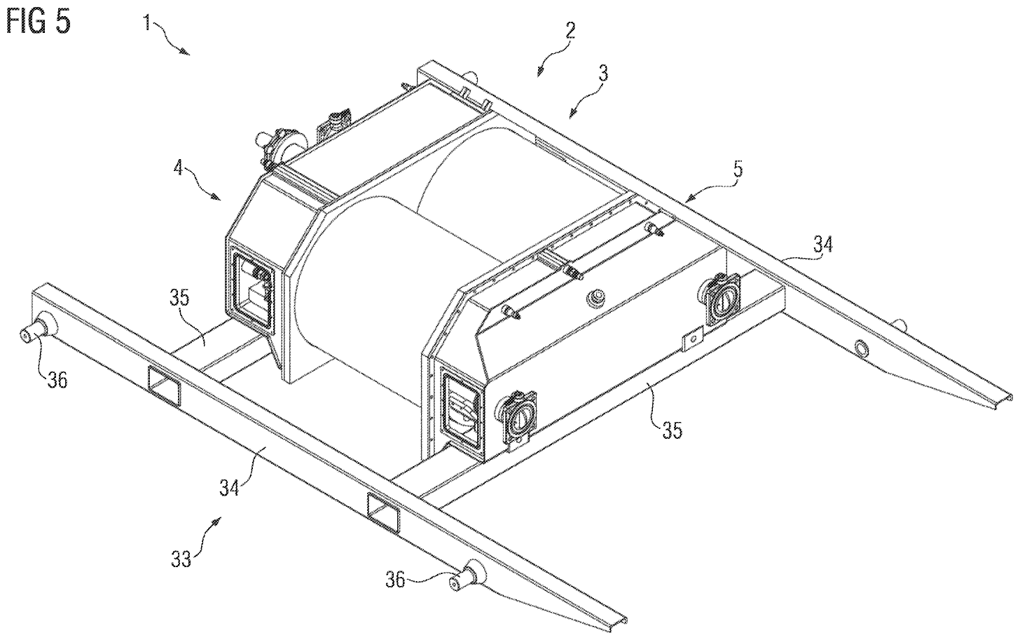

FIG. 5 shows the electrical device according to FIG. 1 on a supporting frame in each case in perspective view.

FIG. 1 shows an exemplary embodiment of the electrical device according to the invention, which is designed as railway transformer 1. The railway transformer 1 has an externally visible housing 1, which comprises a central part 3, a rear end casing 4, and a front end casing 5. The central part 3 comprises two tube sections 6 and 7 as hollow bodies, which delimit a circular cylindrical inner cavity. Respectively one flange portion 8 and 9 is molded onto both front sides of the tube sections 6 and 7, which flange portion extends radially outward from the tube section at right angles to the longitudinal direction of the tube sections 6 and 7. In this case, each flange portion 8 and 9 is configured to be flat. In other words, the outer surface of the flange portions 8 and 9 each lie in a plane. Each end casing 4 and 5 has a corresponding flange portion 10 and 11, wherein the flange portion 10 of the rear end casing 4 lies opposite the flange portion 8 and the flange portion 11 of the front end casing 5 lies opposite the flange portion 9 of the central part 3. Through-holes can be identified in the flange portion 11 of the front end casing 5, in which screws can be disposed, which screws are screwed into holes of the flange portion 9 of the central part 3, which are open on one side. A corresponding fastening is provided for the flange portions 8 and 10, wherein, however, the through-holes are not shown as a result of the selected view.

Disposed between the flange portions 8, 19 or 9, 11 respectively is a circumferential O ring, which is inserted in a groove introduced in each case into the flange portions 8 and 9. By tightening screws not shown in the figures, the flange portions 9 and 11 or 8 and 10 respectively are pressed together, wherein the O ring inserted between them in the groove provides for a fluid-tight connection of these two components as a result of its elastic deformation.

The end casings 4 and 5 have a box-like structure and have a front wall 12 facing away from the respective flange portion 10 or 11 respectively, wherein a side wall 12 extends between the front wall 12 and the flange portion 11. At the corners the box-shaped structure is beveled in order to avoid unnecessary internal volume of the end casings 4 or 5, respectively. Furthermore, hand openings 14 can be identified, which are detachably fastened to the side wall 13 of the end casings 4 or 5, respectively. Furthermore, a high-voltage feedthrough 15 and cable outlets 16 can be seen in the anterior front wall.

L-shaped brackets 17 are used for mechanical reinforcement of the bottom region of the end casings 4 and 5 not shown in the figures, which brackets extend for the most part underneath the end casing 4 or 5 respectively and which are firmly connected to the respective end casing. The brackets are furthermore used to fasten the spacers to the inner side of the respective end casing. Furthermore the brackets and therefore the end casing can be connected more firmly by means of a fastening means.

An active part not shown in FIG. 1 is disposed in the tank or, in other words, the housing 2.

FIG. 2 shows the railway transfer 1 according to FIG. 1 from behind, wherein parts of the housing have been omitted to obtain a free view of the active part 18. The active part 18 comprises two winding assemblies 19 and 20, wherein each winding assembly 19, 20 comprises an outer primary or higher-voltage winding 21 and an inner low-voltage or secondary winding 22. The higher-voltage winding 21 and the lower-voltage winding 22 are each disposed concentrically to one another. As has already been stated, each winding assembly can also have further windings such as, for example, an auxiliary operating winding and/or a step winding. In one variant of the invention, the secondary winding and optionally further windings lie on the outside while the primary winding lies on the inside.

A core leg 23 or 24, respectively, of a core 25 extends through each winding assembly 19 or 20 respectively, which core has, in addition to the core legs 23 and 24, an upper yoke 26 and a lower yoke 27, to which the core legs 23 and 24 of their two ends are connected. In this way, the core 25 forms a closed iron circle. It can be further identified that the winding assemblies 19 or 20 respectively of the active part 18 are each disposed in one of the tube sections 6 or 7 respectively of the central part 3. The tube sections enclose the respective winding assembly over the entire circumference. During operation of the railway transformer, the tank 2 is filled with an insulating fluid, for example, an ester oil, a mineral oil, a silicone oil, or the like. Since the tube sections surround their associated winding assembly over the entire circumference, insulating fluid from the tube section 6 can only enter into the tube section 7 via the internal volume of one of the end casings 4 or 5.

In the axial direction, the winding assemblies 19 or 20 respectively are surmounted by the core legs. The ends of the core legs 24 and the yokes 26, 27 are therefore not disposed in the central part 3 but in the respective end casings 4 or 5 respectively of the tank 2. More precisely, the upper yoke 26 is disposed inside the end casing 4 and the lower yoke 27 is disposed inside the end casing 5. In each case, the active part with its core 25 is disposed completely inside the tank 2.

FIG. 3 shows the structure of the middle 3 of the housing 2 of the railway transformer according to FIG. 1 more precisely. In particular, in this perspective view the tube sections 6 and 7 can be identified as well as the cavities 28 and 29 delimited by them in each case, which are configured to be circular cylindrical. These circular cylindrical hollow cylinders have a somewhat larger radius than the respective winding assembly so that in the radial direction, a uniform spacing of 3-5 mm is provided between winding assembly and inner side of the tube sections. This makes it possible to receive the winding assemblies of the active part fabricated from a non-conducting material in a shape-complementary manner.

FIG. 3 also shows the front flange portion 9 in more detail. In particular, it can be seen that this has holes open on one side, that are provided with an internal thread, into which suitable screws can be screwed. Furthermore the circumferential O ring 31 can be identified, which is used for fluid tight connection of the central part 3 to the respective end casing 4 or 5, respectively.

FIG. 4 shows the end casing 5 of the railway transformer 1 according to FIG. 1 in a perspective view from inside. The hand holes 14 are shown in FIG. 4 without the cover required during operation. A simple plate, which is placed on the side wall and, for example, is firmly connected to the corresponding side wall of the end casing 5 by screwing, is used as cover. A circumferential O ring 31 is again used for fluid tight closure of the hand hole 14. Furthermore, the longitudinal sections of the L-shaped retaining parts 17 can be seen, which enable mounting of the end casing on the bottom region. Furthermore, through-holes 32 can be identified, which enable the insertion of feedthroughs and/or other connections in the interior of the end casing 5.

FIG. 5 shows the railway transformer 1 according to FIG. 1 together with the fastening means 33, which are designed as supporting frame 33. The supporting frame 33 has two mutually opposite longitudinal members 34, which are aligned parallel to one another, between which a front and rear cross member 35 extend. In this case, the railway transformer 1 rests only with its end casings 4 or 5 respectively and specifically with the retaining part 17 mounted firmly on the end casings, on the respective cross member 35 and can be fastened mechanically there. In this way, the introduction of high forces into the central part 3 is avoided. According to the present invention, the central part 3 can therefore be fabricated from a light material and, in the exemplary embodiment shown, consists of a glass-fiber-reinforced base material (GFP). Fastening bolts 36 used to mount the railway transformer 1 on a rail vehicle in the horizontal position project laterally at the longitudinal members 34.

1-12. (canceled)

13. An electrical device for connection to a high voltage, the electrical device comprising:
an active part having a magnetizable core and at least two winding assemblies, each surrounding a core section of said core and having windings that are inductively coupled to one another; and
a tank to be filled with an insulating fluid and containing said active part completely;
said tank having two end casings and a central part arranged between said end casings;
said central part forming a hollow body for each winding assembly, with a respective one of said core sections, surrounded by an associated said winding assembly, extending through said hollow body; and
said hollow bodies being connected to one another on an inside and only via an internal volume of said end casings.

14. The electrical device according to claim 13, wherein each hollow body is a circular-cylindrical tube section.

15. The electrical device according to claim 13, wherein said central part comprises two flat flange sections, between which said hollow bodies extend, wherein each said flange section is mechanically detachably connected to a respective flange section of one of said end casings, and wherein sealing means are disposed between said flange sections.

16. The electrical device according to claim 13, wherein said central part consists of a plastic.

17. The electrical device according to claim 13, wherein said central part is formed of a fiber-reinforced plastic.

18. The electrical device according to claim 13, wherein said end casings are formed of a metal or a metal alloy.

19. The electrical device according to claim 13, wherein said end casings are box-shaped.

20. The electrical device according to claim 13, wherein said end casings are formed to be complementary in shape relative to a section of said active part, opposite to which said end casings are located.

21. The electrical device according to claim 13, wherein at least one of said end casings is formed with at least one of a viewing window or a hand opening.

22. The electrical device according to claim 13, wherein said core has two core legs and an upper yoke and a lower yoke connecting said core legs to one another, and wherein each of said core legs extends through one of said hollow bodies and is surrounded by a respective said winding assembly.

23. The electrical device according to claim 13, wherein said active part is only mechanically connected to said tank at said end casings, and wherein said end casings are connected to fastening means for mounting on a rail vehicle.

24. The electrical device according to claim 23, wherein said end casings are each connected to a cross member of a supporting frame.
